(19) United States
(12) Patent Application Publication
(10) Pub. No.: US 2005/0038553 A1
(43) Pub. Date: Feb. 17, 2005

(54) System and method for managing the production of a custom designed product

(75) Inventors: David Allen Sweitzer, York, PA (US); John Evan Bade, York, PA (US); Christopher Neuman, York, PA (US); Eric Scott Avery, Etters, PA (US); Mark R. Hartenstein, Waterloo, IL (US); Kevin L. Stein, York, PA (US)

Correspondence Address: MCNEES, WALLACE & NURICK LLC, 100 PINE STREET, P.O. BOX 1166, HARRISBURG, PA, 17108-1166, US

(73) Assignee: YORK INTERNATIONAL CORPORATION, York, PA (US)

(21) Appl. No.: 10/916,860

(22) Filed: Aug. 12, 2004

Related U.S. Application Data
(60) Provisional application No. 60/495,384, filed on Aug. 15, 2003.

(51) Int. Cl. G06F 19/00

(52) U.S. Cl. 700/182; 700/98

(57) ABSTRACT

A production management system and method for managing the production of a custom designed product including user-friendly product configuration software to configure the product, such as an AHU, to the user's requirements. Once the product has been configured, manufacturing resource planning software automatically provides information from the product configuration software to generator software. The generator software corresponds to each uniquely configurable component of the product to automatically produce a customized model of the component, or customized component, for use with the custom product. The manufacturing resource planning software automatically prepares drawings of the customized component for manufacture.

### CROSS REFERENCE TO RELATED APPLICATIONS

This Application claims the benefit of U.S. Provisional Application No. 60/495,384, filed Aug. 15, 2003.

### BACKGROUND OF THE INVENTION

The present invention relates generally to managing the production of a product. More specifically, the present invention relates to managing the production of a custom designed air handling unit.

Air Handling units (AHUs) are used in commercial buildings to move, filter and condition supply air to occupied spaces. They are structures containing typically fans, motors, coils, filters, dampers, and often more specialized components such as energy wheels, air blenders, etc. AHUs are located either inside commercial/institutional space (in equipment rooms) or outside and adjacent to commercial/institution space, including rooftop installations.

A broad spectrum of components, space limitations, access requirements and application variability require that AHUs are highly configurable.

Manufacturers of AHUs have been forced to manage the balance of offering greater flexibility in componentry, dimensions, and configurations with their ability to execute the orders into their manufacturing process. Because of this, two market segments exist: Standard AHU manufacturers who have limited flexibility, but have pre-engineered/designed each AHU and all of its permeations or Custom AHU manufacturers who provide extreme flexibility, but who engineer/design each AHU upon receipt of order. Consequently, a purchaser must either accept a pre-designed AHU that may be readily available for delivery, but ill suited for the purchaser's facility requirements, or possibly being forced to wait an extended period of time for delivery of a properly configured AHU that must first be designed, and likely paying a premium price for the custom design.

What is needed is a system and method that automates a significant portion of the manufacturing process for quickly and efficiently producing an AHU that is extremely configurable.

### SUMMARY OF THE INVENTION

The present invention relates to a production management software system that automates the configuration process of the AHU and directly automates the creation of a manufacturing bill of material for that AHU including all internal components, sub assemblies, piece parts, floors, bases, and hardware.

Manufacturing data for piece parts is automatically generated and sent directly to automated special purpose manufacturing equipment such as cut to length lines, roll formers, line testers as well as traditional nesting software. Manufacturing data includes part number, cut size, standard labor content and Part Configuration data.

The production management software system is a distributed and centralized collection of interconnected software systems that automate the selection and configuration of the AHU, the design of the unit and all sub-assemblies and parts and directly feeds all required data for manufacturing resource planning systems (MRP).

The production management software system supports multiple manufacturing facilities—automatically tailoring key manufacturing data to the facility.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates schematically the interaction of components of the production management system of the present invention.

FIG. 2 illustrates schematically the interaction of components of the manufacturing order management software to automatically configure AHU panel hardware components of the present invention.

FIG. 3 illustrates an engineering drawing generated by the generator model software of the present invention.

FIG. 4 illustrates a specification sheet created by the manufacturing order management software of the present invention.

Wherever possible, the same reference numbers will be used throughout the drawings to refer to the same or like parts.

### DETAILED DESCRIPTION OF THE INVENTION

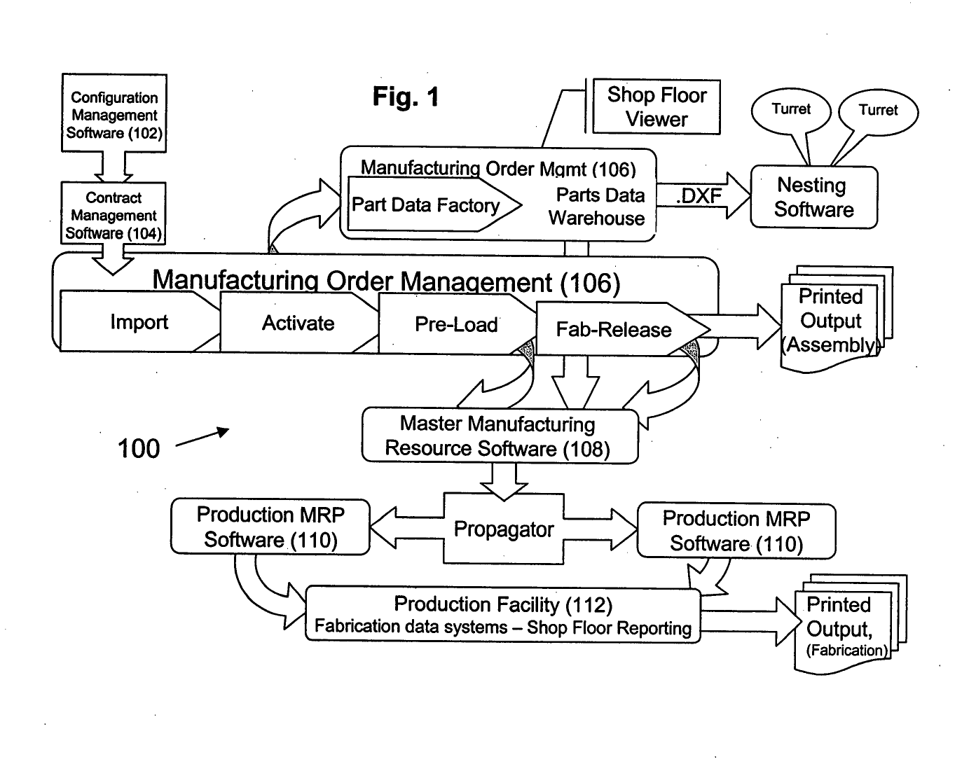

FIG. 1 illustrates the components of the production management system 100 of the present invention. A user would interact with product configuration software or programs 102 to design and configure the product, preferably an AHU, to the user's requirements. Once the product has been configured and is ready to be ordered and produced, the user submits the product order to contract management software 104 to manage the business aspects of the order such as invoicing and shipping authorizations. The contract management software 104 provides the specific details on the product configuration to manufacturing order management software 106 and some order information to manufacturing resource planning software 108. The manufacturing order management software 106 generates a bill of material for the product order and transmits the bill of material to the manufacturing resource planning software 108.

The manufacturing resource planning software 108 converts the bill of material from the manufacturing order management software 106 into a production facility specific bill of material. The production facility specific bill of material is provided to the corresponding production manufacturing resource planning software 110 for the production facility. In addition, the manufacturing resource planning software 108 can place orders for items on the production facility specific bill of material required by the production facility. The production manufacturing resource planning software 110 provides information to the corresponding production facility 112 using propagator software using information on the production facility provided by the contract management software 104. The production facility 112 preferably has facility reporting software that can manage information from the production manufacturing resource planning software 110. In addition, the production facility 112 can receive information such as drawings and test plans from the manufacturing order management software 106.

Test plans supplied by the manufacturing order management software 106 are configured and supplied to a test bench at the production facility to test the operation of the air handling unit or portions of the air handling unit as desired. The instructions are preferably simple, such as “GO/NO GO,” thus not requiring highly skilled technicians to run and evaluate the tests. Upon completion of the test plan, the test bench generates a test report.

Configuration Software

Configuration management software 102 permits user interaction to configure a product. The user is sequentially prompted by the configuration management software 102 to provide responses to assist with product configuration. For example, for AHUs, the user is prompted for footprint size, that is, the amount of floor space that is available for the AHU. The user is also prompted for information relating to the desired performance capacities required for the AHU, such as air flow, or cooling or heating capacity. After this information has been input by the user, the configuration management software 102 prompts for additional information, such as identifying the different required components for the AHU. For example, if the user responded that a fan was required, configuration management software 102 would provide a list of fans that satisfied the capacity requirement earlier provided by the user. If no fan configuration was available that satisfied the user's requirements, a message would be provided to alert the user of this situation. The user could then modify the requirements, or if the component was optional or multiple types of the component were available, the user could further query the configuration management software 102, if desired.

Not only does the configuration management software 102 provide the user with configuration options, but it also ensures that the components are properly arranged. Thus, if a fan required a certain fitting or interface which included options requiring further user interaction, the configuration management software 102 would alert the user of this situation. The configuration management software 102 does not permit the user to proceed further in the configuration process until the fitting has been selected. As the components are selected and compiled, the configuration management software 102 provides a proportional two dimensional representation of the components for the user. Once the configuration management software 102 has confirmed that no additional components are required to supplement the AHU configuration identified by the user, the configured AHU can be saved, and the user can exit the software. That is, the distributed Windows® based configuration management software 102 allows users to configure all elements of an AHU within the confines of engineering rule sets. In other words, the configuration management software 102 ensures that the AHU configuration created by the user not only satisfies the performance criteria specified by the user, but that the components selected are compatible, in proper sequential order to function together properly, and that there are no missing components. The configuration management software 102 automatically produces pricing, performance information, a scaled two dimensional drawing, and specifications of each AHU. Additionally, the configuration management software 102 places the data regarding a particular AHU in an XML file format, and automatically passes this file through the contract management software 104 to the manufacturing order management software 106.

Contract Management Software

Contract management software 104 (CMS) is a centralized data management system for maintaining and managing the equipment backlog of the business. CMS 104 receives information from the configuration management software 102, such as XML and PDF file formats. Upon receiving an order from the customer for the AHU, the CMS 104 assigns an order number, assigns a production facility 112, possibly more than one facility 112, to manufacture the AHU, and manages invoicing and shipment of the authorization of the order to the customer.

Manufacturing Order Management Software

Manufacturing order management software 106 (MOM) is a centralized system that produces the manufacturing bill of material from the configuration software 102 XML data, internal MOM software 106 rule sets and databases of all parts. The bill of material consists of purchased parts, sheet metal parts and sub-assemblies, labor, hardware and miscellaneous items. The bill of material is published to the manufacturing resource planning software 108, also referred to as the Master MRP environment, or Master MRP. Creation of specific elements of the bill of material is discussed in further detailed below.

MOM software 106 selects all purchased parts required and automatically publishes this information to MRP software 108 which places these parts on order from the vendor.

MOM software 106 initiates automatic design of all piece parts required for the AHU based upon selected size of the AHU unit, components chosen, configuration and current engineering revision levels of parts models. Parts are created when MOM software 106 sends part parameters to one of many 3D generator models, such as one that is available from Autodesk, Inc., which spawn the correct instance of the part for the specific AHU unit.

MOM software 106 automatically creates the unitized shell of each AHU. The shell includes all structural members such as horizontal and vertical raceways, panels, and base rails. MOM software 106 selects the optimum panel configuration for the AHU unit based upon size, configuration, location of doors, pipe chases, openings and drain pans. Similarly base rails, internal parts and internal bulkheads are created. Then MOM software 106 sends panel, base rail, internal parts and bulkhead arrangements to the Raceway generator which creates raceways with all required apertures formed in the raceways to mate up with all panels, bulkheads and base rails. In other words, all components fabricated using software of the present invention should be provided with all apertures required for any mating parts prior to assembly of the components. This functionality allows the production management system 100 to “unitize” a series of AHU segments into a single holistic AHU.

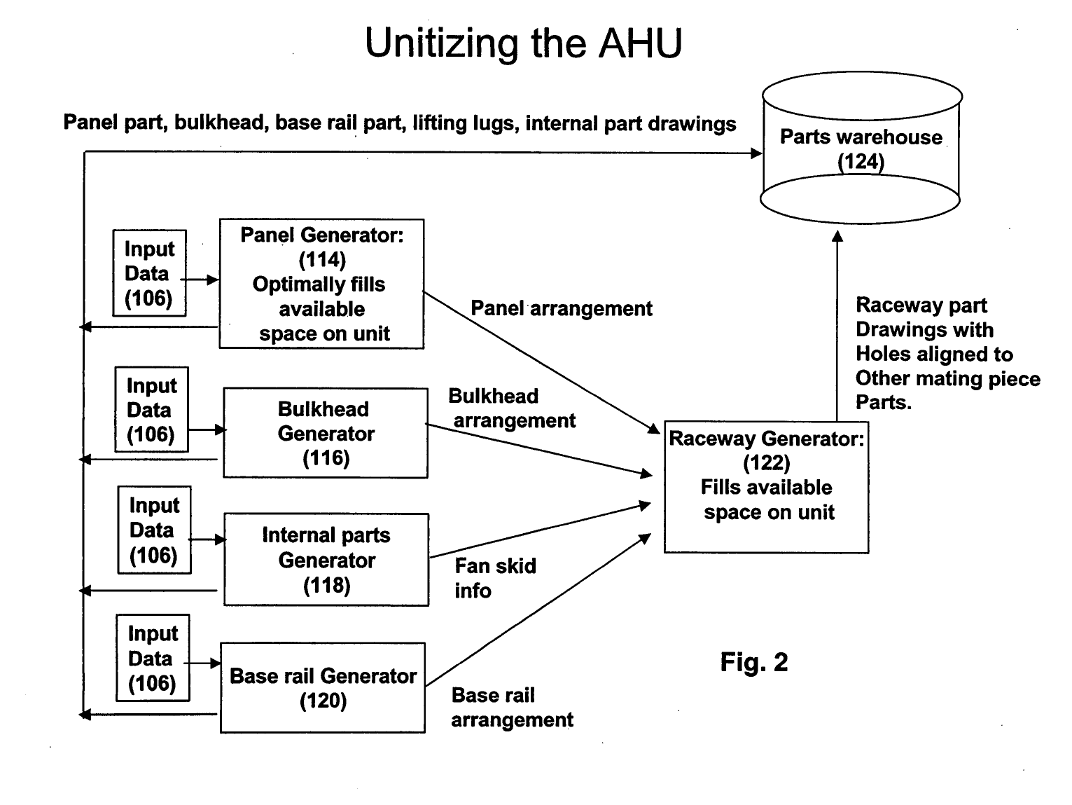

Referring to FIG. 2, the generator models 114, 116, 118, 120, 122 automatically design customized parts that make up the AHU framework components. For example, a panel generator 114 generates a 3D model for the panel arrangement of the AHU; a bulkhead generator 116 generates bulkhead arrangements which may be necessitated by shipping size limitations; an internal parts generator 118 generates the required internal parts which is then utilized to provide supporting hardware fittings, such as for a fan skid; a base rail generator 120 generates a base rail arrangement for supporting the base of the AHU; a raceway generator 122 receives information from the other generators, such as length information for raceways that must be cut to accommodate shipping splices, and the hole patterns to ensure the raceway hole patterns align with splice connectors. The generator models are not to be confused with configuration software 102 which provides an overall system configuration and major components that collectively fit within the user specified footprint.

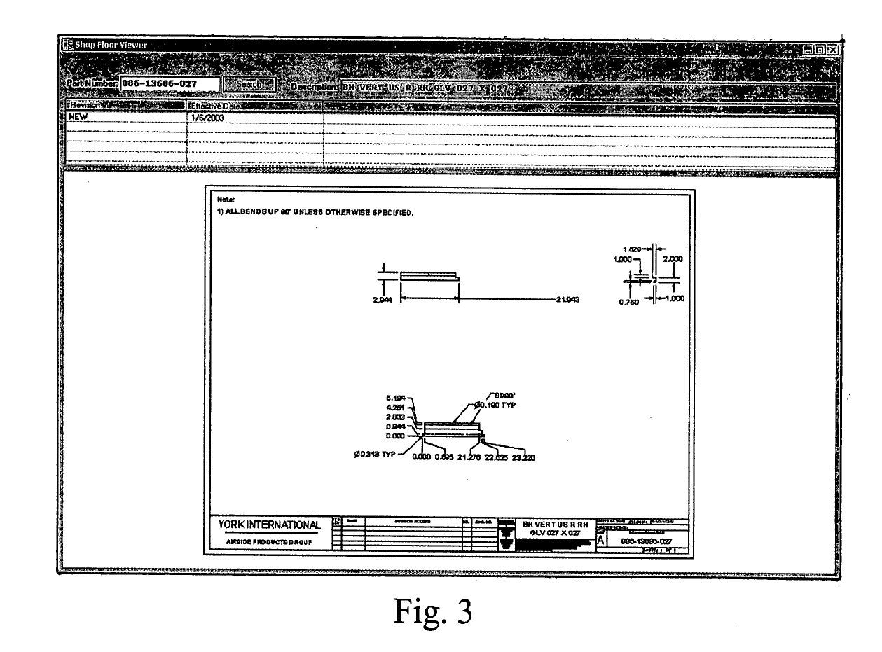

The generator models of the present invention utilize model driven parts generation, versus equation driven parts generation. Equation driven parts generation uses engineering rules to create equations that generate drawings which are then used to create parts. In contrast, model driven parts generation provides specific part parameter information generated from the configuration software 102 into a 3D drawing model of a generator model. Upon receipt of the part parameter information in a generator model, the generator model resizes the model to produce the correct part for a particular AHU unit. The generator model then automatically creates a drawing file for manufacturing, such as shown in FIG. 3.

MOM software 106 stores all parts drawings in the parts data warehouse 124 for possible re-use and so that parts drawings can be accessed directly from the parts data warehouse 124 by the shop floor viewers during the punch and break processes that are used to fabricate the parts.

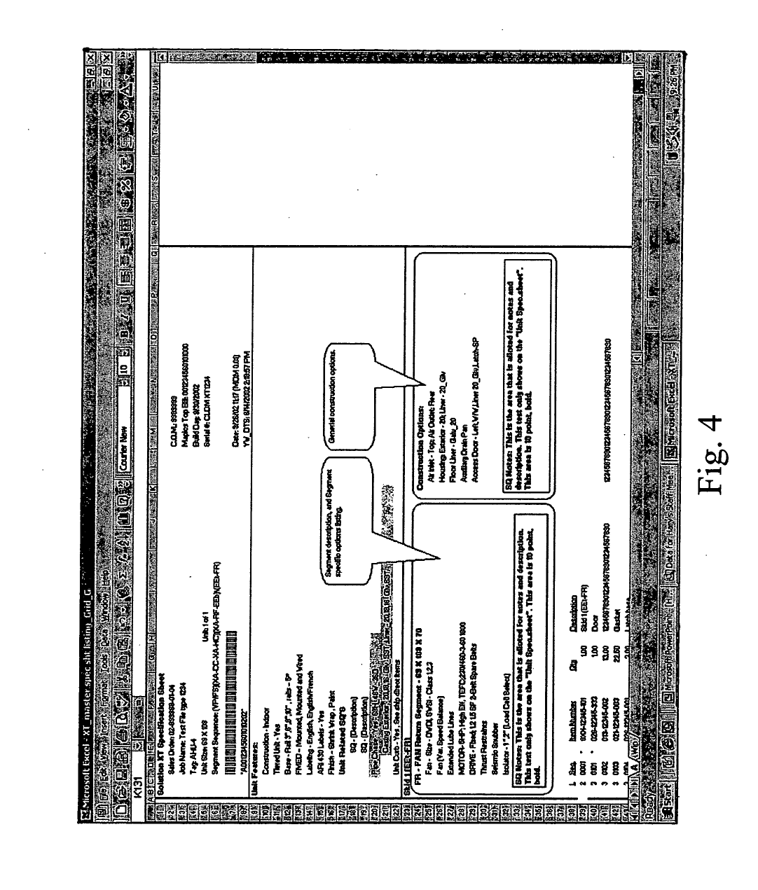

MOM software 106 generates assembly paperwork for each unit which provides concise instruction to the assembly crews. This includes specification sheets (FIG. 4), bulkhead sheets, panel sheets and graphically displays how the unit is to be assembled. Additionally, MOM software 106 generates all unit specific labels required.

MOM software 106 generates all of the DXF drawing information files for each piece part which is used by the sheet metal nesting software to start the sheet metal fabrication process.

Propagator

MOM software 106 publishes the bill of material to the Master MRP environment 108. This data is propagated to production MRP environments 110 automatically. This step allows MOM software 106 to publish generic manufacturing information which is automatically tailored to the various production environments based on characteristics for each production facility 112 such as make vs. buy of components, labor rates, MRP purchasing codes, etc.

When CMS 104 demand places a unit to a specific production facility 112, CMS 104 automatically amends the top bill information with a flag to signify the facility. Propagator uses this flag to determine which set of filters to use on the bill of material information in the master MRP environment.

Shop Floor Reporting System

Shop Floor reporting is a database system which queries and organizes data in the production MRP environment 110 for sheet metal fabrication. Shop Floor groups parts by manufacturing release (groups of AHU units to be processed).

Shop Floor gathers all parts for nesting in a release and places them in the nesting software queue.

Shop Floor gathers all parts for raceway production in a release and places them in the raceway controller queue.

Shop Floor creates paperwork for all parts by fabrication process (shear, bend, punch) for a manufacturing release.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A system for automatically producing a component for a custom designed product comprising:
product configuration software for prompting a user for operating parameters of the product, the product configuration software creating information associated with the product;
manufacturing order software comprising a plurality of software generator models, each of the plurality of software generator models having a three dimensional model of a component of the product, each of the plurality of software generator models receiving information from the product configuration software automatically resizing the three dimensional model of the component to create a custom designed component, the manufacturing order software automatically generating a drawing of each custom designed component;
an interface with a plurality of manufacturing devices for machining the custom designed component.

2. The system of claim 1 wherein the custom designed product is an air handling unit.

3. The system of claim 2 wherein the plurality of software generator models includes software models for creating customized components comprising a framework of the air handling unit framework.

4. The system of claim 3 wherein the plurality of software generator models includes software models for creating customized components selected from the group consisting of a panel generator model, a bulkhead generator model, an internal parts generator model, a base rail generator model and a raceway generator model.

5. The system of claim 3 wherein the plurality of software generator models utilizes a model driven parts generation technique.

6. The system of claim 5 wherein each of the plurality of software generator models generates a drawing file of a created customized component.

7. The system of claim 4 wherein the customized components include apertures to secure to mating components.

8. The system of claim 2 wherein the configuration software configures the air handling unit within confines of an engineering rule set.

9. The system of claim 8 wherein the configuration software produces pricing of each air handling unit.

10. The system of claim 8 wherein the configuration software performs tasks for each air handling unit selected from the group consisting of producing performance information, producing a scaled two dimensional drawing and producing specifications.

11. The system of claim 2 further comprising contract management software to maintain and manage an equipment backlog.

12. The system of claim 11 wherein the contract management software assigns at least one production facility to manufacture the air handling unit.

13. The system of claim 12 wherein the contract management software publishes a bill of material of the air handling unit to master material resource planning software to automatically tailor manufacturing information for each of the at least one production facility.

14. The system of claim 13 wherein the manufacturing order software providing test plans for each of the at least one production facility.

15. The system of claim 13 wherein the manufacturing order software providing drawings for each of the at least one production facility.

16. A method for automatically producing a component for a custom designed product comprising:
providing product configuration software, manufacturing order software comprising a plurality of software generator models, each of the plurality of software generator models having a three dimensional model of a component of the product; and an interface with manufacturing devices;
inputting operating parameters of the product into the product configuration software, the product configuration software creating information associated with the product;
receiving information from the product configuration software by each of the plurality of software generator models to automatically resize the three dimensional model of the component to create a custom designed component;
machining the custom designed component with the manufacturing devices using the interface.

17. The method of claim 16 wherein the custom designed product is an air handling unit.

18. The method of claim 17 wherein the plurality of software generator models includes software models for creating customized components comprising a framework of the air handling unit framework.

19. The method of claim 18 wherein the plurality of software generator models includes software models for creating customized components selected from the group consisting of a panel generator model, a bulkhead generator model, an internal parts generator model, a base rail generator model and a raceway generator model.

20. The method of claim 18 wherein the plurality of software generator models utilizes a model driven parts generation technique.

21. The method of claim 20 wherein each of the plurality of software generator models generates a drawing file of a created customized component.

22. The method of claim 19 wherein the customized components include apertures to secure to mating components.

23. The method of claim 17 wherein the configuration software configures the air handling unit within confines of an engineering rule set.

24. The method of claim 16 wherein the configuration software performs tasks for each air handling unit selected from the group consisting of producing performance information, producing a scaled two dimensional drawing and producing specifications.

25. The method of claim 17 wherein the step of providing product configuration software further comprising contract management software to maintain and manage an equipment backlog.

26. The method of claim 25 wherein the contract management software assigns at least one production facility to manufacture the air handling unit.

27. The method of claim 26 wherein the contract management software publishes a bill of material of the air handling unit to master material resource planning software to automatically tailor manufacturing information for each of the at least one production facility.

28. The method of claim 27 wherein the manufacturing order software providing test plans for each of the at least one production facility.

29. The method of claim 27 wherein the manufacturing order software providing drawings for each of the at least one production facility.
